(19) United States
(12) Patent Application Publication
(10) Pub. No.: US 2019/0045001 A1
(43) Pub. Date: Feb. 7, 2019

(54) UNSUPERVISED ANOMALY DETECTION USING SHADOWING OF HUMAN COMPUTER INTERACTION CHANNELS

(71) Applicant: CA, Inc., Islandia, NY (US)

(72) Inventor: Serge Mankovskii, Morgan Hill, CA (US)

(73) Assignee: CA, Inc., Islandia, NY (US)

(21) Appl. No.: 15/667,512

(22) Filed: Aug. 2, 2017

(51) Int. Cl. H04L 29/08; G06F 21/55

(52) U.S. Cl. CPC H04L 67/1095; G06F 21/57; G06F 21/55

(57) ABSTRACT

Technologies are provided in embodiments to detect anomalies by shadowing human-computer interaction channels. Embodiments include accessing a shadow signal generated by a shadowing device. In an embodiment, the shadow signal can be a video input stream of display screen images rendered on a display screen, where the display screen images were recorded by the shadowing device. The embodiment also includes identifying, at the shadowing device, a first frame of the video input stream, and determining whether an anomaly is associated with the video input stream based, at least in part, on applying a rule of a set of rules to at least a portion of the first frame, where the set of rules defines a control image associated with the video input stream. The embodiment further includes determining whether to take an action based on the determining whether the anomaly is associated with the video input stream.

### BACKGROUND

The present disclosure relates generally to the field of human computer interaction channels, and more specifically, to unsupervised anomaly detection using shadowing of human computer interaction channels.

Human-computer interaction (HCI) channels are integrated into most segments of society. HCI channels include electronic display screens that are used to convey information to humans in both public and private settings, and can be used in both civil and military applications. For example, computer display screens can be used to convey information to humans in public transportation facilities, top-secret military operations, environmental monitoring systems, and home security monitoring systems, among many other examples. Typically, a human operator monitors information rendered on a display screen to know when the information changes to convey new or updated information to the human operator. Depending on the type of information and the format utilized to display the information, the human operator may inadvertently fail to see the updated or new information. Moreover, some display screens may present critical information, for example, potentially affecting human lives or property. Changes in the information may be conveyed using a barrage of lights, sounds, and/or other communications designed to draw attention from humans. This can reduce the effectiveness of anyone monitoring the display screens and also drown important messages in the redundancy of duplicated signals and extraneous noise.

### BRIEF SUMMARY

According to one aspect of the present disclosure, a video input stream of a display screen images rendered on a display screen of a display device can be accessed, where the display screen images were recorded by a shadowing device to produce the video input stream. A first frame of the video input stream can be identified. A determination can be made as to whether an anomaly is associated with the video input stream based, at least in part, on applying a rule of a set of rules to at least a portion of the first frame, where the set of rules defines a control image associated with the video input stream. A determination can be made as to whether to take an action based on determining whether the anomaly is associated with the video input stream.

### BRIEF DESCRIPTION OF THE DRAWINGS

FIG. 1 is a simplified schematic diagram of an example computing environment for anomaly detection in human computer interaction (HCI) channels according to at least one embodiment.

FIG. 2 is a simplified block diagram illustrating additional possible details of one embodiment of an example computing environment for anomaly detection in an HCI channel according to at least one embodiment.

FIG. 3 is a simplified flowchart illustrating example techniques associated with anomaly detection in an HCI channel according to at least one embodiment.

FIG. 4 is a simplified block diagram illustrating additional possible details of another embodiment of an example computing environment for anomaly detection in an HCI channel according to at least one embodiment.

FIG. 5 is a simplified flowchart illustrating further example techniques associated with anomaly detection in an HCI channel according to at least one embodiment.

FIG. 6 is a simplified flowchart illustrating yet further example techniques associated with anomaly detection in an HCI channel according to at least one embodiment.

FIG. 7 is a simplified flowchart illustrating yet further example techniques associated with anomaly detection in an HCI channel according to at least one embodiment.

FIG. 8 is a simplified flowchart illustrating yet further example techniques associated with anomaly detection in an HCI channel according to at least one embodiment.

Like reference numbers and designations in the various drawings indicate like elements.

### DETAILED DESCRIPTION

As will be appreciated by one skilled in the art, aspects of the present disclosure may be illustrated and described herein in any number of patentable classes or contexts including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” “logic,” “engine,” “generator,” “agent,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium includes the following: a portable computer diskette, a hard disk, a random access memory (RAM), a read-only memory (ROM), a programmable read-only memory (PROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, assembly language, or other programming languages. The program code may execute entirely on a local computer (e.g., server, server pool, desktop, laptop, appliance, etc.), partly on the local computer, as a stand-alone software package, entirely on a remote computer, or partly on a local computer and partly on a remote computer. In the latter scenarios, the remote computer may be connected to the local computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS). Generally, any combination of one or more local computers and/or one or more remote computers may be utilized for executing the program code. Additionally, at least some of the program code may execute on a mobile device (e.g., smart phone, a tablet, etc.).

Aspects of the present disclosure are described herein with reference to flowchart illustrations and/or block diagrams of methods, apparatuses, systems, and computer program products according to embodiments of the disclosure. It will be understood that each block of the flowchart illustrations and/or block diagrams, or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses, or other devices to produce a computer implemented process such that the instructions, which execute on the computer or other programmable apparatus, provide processes for implementing the functions/acts specified in the flowchart and/or block diagram block or blocks.

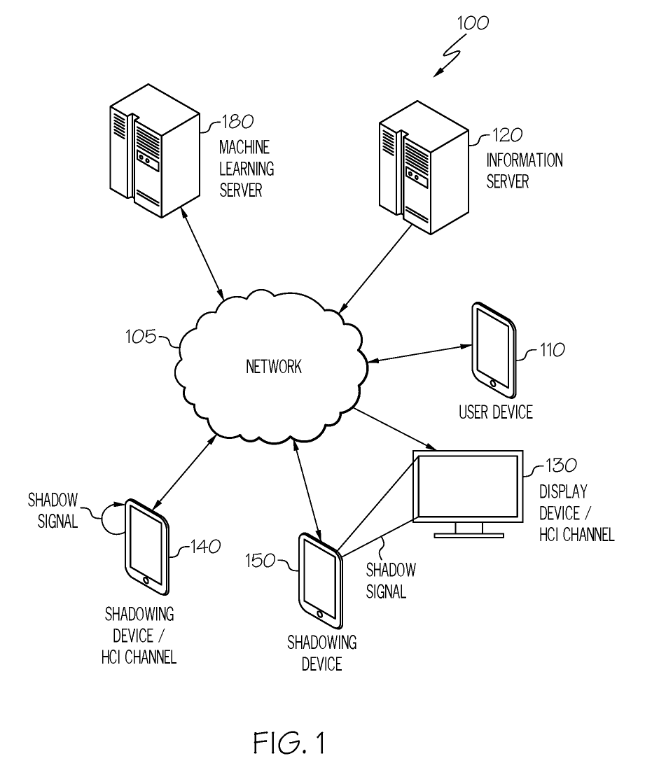

Referring now to FIG. 1, a simplified block diagram is shown illustrating an example computing environment 100 in which unsupervised anomaly detection using shadowing of a human-computer interaction (HCI) channel is implemented. Computing environment 100 can include several elements such as a user device 110, an information server 120, a machine learning server 180, a first HCI channel (e.g., display device 130), shadowing devices 140 and/or 150, and a network 105 for communications between the elements of computing environment 100. Shadowing device 140 may also include its own display screen that functions as a second HCI channel. Information server 120 can be configured to provide information to a human via an HCI channel. In an HCI channel, the information is rendered on a display screen in a human-cognizable configuration with human-understandable imagery. For example, information server 120 may provide such information to be rendered on the display screen of shadowing device 140 and/or on a display screen of display device 130. Shadowing device 140 generally represents a computing device implementing one possible embodiment of unsupervised anomaly detection in which the shadowing device 140 captures and evaluates shadow signals, such as data output signals, that are to be displayed as images on a display screen of shadowing device 140. Shadowing device 150 generally represents a computing device implementing another possible embodiment of unsupervised anomaly detection in which the shadowing device 150 records and evaluates images displayed on a separate display screen, such as the display screen of display device 130. Accordingly, either shadowing device 140 or shadowing device 150, or both may be implemented in computing environment 100.

With reference to various elements of FIG. 1, a description of the infrastructure of computing environment 100 is now provided. Elements of FIG. 1 may be coupled to one another through one or more interfaces employing any suitable connections (wired or wireless), which provide viable pathways for network communications. Additionally, any one or more of the elements of FIG. 1 may be combined or removed from the architecture based on particular configuration needs. For example, the elements of FIG. 1 may be implemented on separate physical or virtual machines. In other examples, information server 120 and/or machine learning server 180 could be integrated with shadowing device 140 and/or with shadowing device 150. Furthermore, information server 120 and/or machine learning server 180 could be locally provisioned with shadowing device 140 and/or shadowing device 150. In another example, information server 120 may be provisioned in a cloud or otherwise distributed to remotely provide information to be rendered on a display screen. Machine learning server 180 may be provisioned in a cloud or otherwise distributed to remotely provide machine learning functions for data captured by shadowing devices 140 and/or 150.

Generally, computing environment 100 can include any type or topology of networks. Within the context of the disclosure, networks such as network 105, represent a series of points or nodes of interconnected communication paths for receiving and transmitting packets of information that propagate through computing environment 100. A network, such as network 105, can comprise any number of hardware and/or software elements coupled to (and in communication with) each other through a communication medium. Such networks can include, but are not limited to, any local area network (LAN), virtual local area network (VLAN), wide area network (WAN) such as the Internet, wireless local area network (WLAN), metropolitan area network (MAN), Intranet, Extranet, virtual private network (VPN), any other appropriate architecture or system that facilitates communications in a network environment or any suitable combination thereof. Additionally, radio signal communications over a cellular network may also be provided in computing environment 100. Suitable interfaces and infrastructure may be provided to enable communication with the cellular network. Furthermore, lenses may be provided in a shadowing device (e.g., 150) to focus light from a scene, such as a display screen image on display device 130, onto an image sensor for recording the display screen image. Similarly, sound waves can be captured by an audio sensor in a shadowing device (e.g., 140, 150) for recording audio.

Communications in computing environment 100 may be inclusive of packets, messages, requests, responses, replies, queries, etc. Communications may be sent and received according to any suitable communication messaging protocols, including protocols that allow for the transmission and/or reception of packets in a network. Suitable communication messaging protocols can include a multi-layered scheme such as Open Systems Interconnection (OSI) model, or any derivations or variants thereof (e.g., transmission control protocol/IP (TCP/IP), user datagram protocol/IP (UDP/IP), etc.). Particular messaging protocols may be implemented in computing environment 100 where appropriate and based on particular needs. Additionally, the term ‘information’ as used herein, refers to any type of binary, numeric, voice, video, textual, multimedia, rich text file format, HTML, portable document format (pdf), or script data, or any type of source or object code, or any other suitable information or data in any appropriate format that may be communicated from one point to another in electronic devices and/or networks.

In general, “servers,” “computing devices,” “computing systems,” “network elements,” “database servers,” “shadowing devices,” “systems,” “display devices,” etc. (e.g., 110, 120, 130, 140, 150, 180, etc.) in example computing environment 100, can include electronic computing devices or systems operable to receive, transmit, process, store, or manage data and information associated with computing environment 100. As used in this document, the terms “computer,” “processor,” “processor device,” and “processing element” are intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, computing devices, computing systems, network elements, database servers, systems, client devices, systems, display devices, etc. (e.g., 110, 120, 130, 140, 150, 180, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, information server 120, machine learning server 180, and/or other sub-systems of computing environment 100 can be at least partially (or wholly) cloud-implemented, web-based, or distributed to remotely host, serve, or otherwise manage data, software services and applications interfacing, coordinating with, dependent on, or used by other systems, services, and devices in computing environment 100. In some instances, a server, system, subsystem, and/or computing device can be implemented as some combination of devices that can be hosted on a common computing system, server, server pool, or cloud computing environment and share computing resources, including shared memory, processors, and interfaces.

In one implementation, display device 130, shadowing devices 140 and 150, information server 120, and machine learning server 180 include software to achieve (or to foster) the unsupervised anomaly detection using shadowing of HCI channels, as outlined herein. Note that in one example, each of these elements can have an internal structure (e.g., a processor, a microprocessor, a memory element, etc.) to facilitate at least some of the operations described herein. In other embodiments, these anomaly detection features may be executed externally to these elements, or included in some other network element to achieve this intended functionality. Alternatively, display device 130, shadowing devices 140 and 150, information server 120, and machine learning server 180 may include this software (or reciprocating software) that can coordinate with other network elements in order to achieve the operations, as outlined herein. In still other embodiments, one or several devices may include any suitable algorithms, hardware, software, firmware, components, modules, interfaces, and/or objects that facilitate the operations thereof.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located externally to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

For purposes of illustrating certain example techniques of unsupervised anomaly detection using shadowing of an HCI channel in computing environment 100, it is important to understand the communications that may be traversing the network environment. The following foundational information may be viewed as a basis from which the present disclosure may be properly explained.

With countless electric machines being used in everyday life, including industries, transportation, buildings, homes, and more, some machine failures can potentially lead to the loss of property or even human life. Some failures could lead to expensive industry shutdowns. Other failures may not necessarily result in catastrophic consequences, but nevertheless could lead to the annoyance and frustration of humans. Environmental conditions also have the potential to affect property and/or human life. Thus, monitoring infrastructures are frequently used to monitor (e.g., observe, check progress of, check quality of, surveil, etc.) machines, environmental conditions, humans, animals, places, and numerous other things capable of being monitored to provide meaningful information about the thing being monitored, and to provide information related to the monitoring via an HCI channel for human consumption.

Generally, monitoring can be performed on anything to which an appropriate sensor, camera, or other monitoring device can be coupled. Typically, monitoring infrastructures access data streams from sensors or other monitoring devices that provide signals indicative of the state or condition of the thing being monitored. Information derived from these data streams can be rendered in various human-understandable imagery on one or more electronic display screens of an HCI channel. The information can be displayed in any suitable format according to the particular information being displayed, and the needs and implementations of the monitoring infrastructure.

Human-computer interaction (HCI) channels are used in a wide variety of capacities (e.g., private, public, semi-private/public, civil, military, etc.) to convey information related to the things being monitored. Specific use examples of HCI channels include, but are not limited to, electronic display screens used to convey information in transportation facilities and vehicles, entertainment venues, sporting venues, research laboratories, manufacturing facilities, utility operations, retail establishments, medical facilities and equipment, security systems (e.g., public, private, and semi-private/public entities, homes, etc.), government facilities, and military facilities and operations, among other examples. Thus, data streams used to extract information to be rendered on display screens of HCI channels can originate from a wide variety of disparate sources.

In many scenarios, a human operator monitors information being displayed in a display screen to know when the information changes to convey new or updated information to the human operator. In some scenarios, depending on the type of information and the format utilized to display the information, a human operator may inadvertently fail to see the updated or new information. Moreover, some display screens may present critical information, for example, potentially affecting human lives or property. Changes in the information may be conveyed using a barrage of lights, sounds, and/or other communications designed to draw attention from the human. This can reduce the effectiveness of human operators and also drown important messages in the redundancy of duplicated signals and extraneous noise.

Human operators often need to monitor display screens of HCI channels in order to identify anomalies in the information being presented. In some scenarios, where time-sensitive or critically important information is displayed, human monitoring may be required continuously or substantially continuously. For example, a flight information display screen may need to be monitored often by a passenger to determine whether the relevant plane is on-time or delayed, and whether a gate change has been made. In another example, a patient monitor coupled to a patient may need to be checked regularly to ensure that the patient's vital signs have not changed or gotten worse. In yet a further example, a home security system may need to be monitored to determine when an intruder enters the premises.

Human monitoring of display screens, however, is not always sufficient and is prone to errors. For example, a human operator may inadvertently fail to see updated or new information. Where monitoring is not performed continuously, important updates or new information may be missed altogether when displayed during a non-monitored period. Furthermore, in some scenarios, changes in the information may be conveyed using a barrage of lights, sounds, and/or other communications designed to draw attention from the human operator. In some situations, these lights, sounds, and other communications can be conveyed via multiple HCI channels (e.g., multiple display screens, personal devices, personal computers, etc.). This can reduce the effectiveness of a human operator monitoring a particular HCI channel and can drown important messages in the redundancy of duplicated signals and extraneous noise.

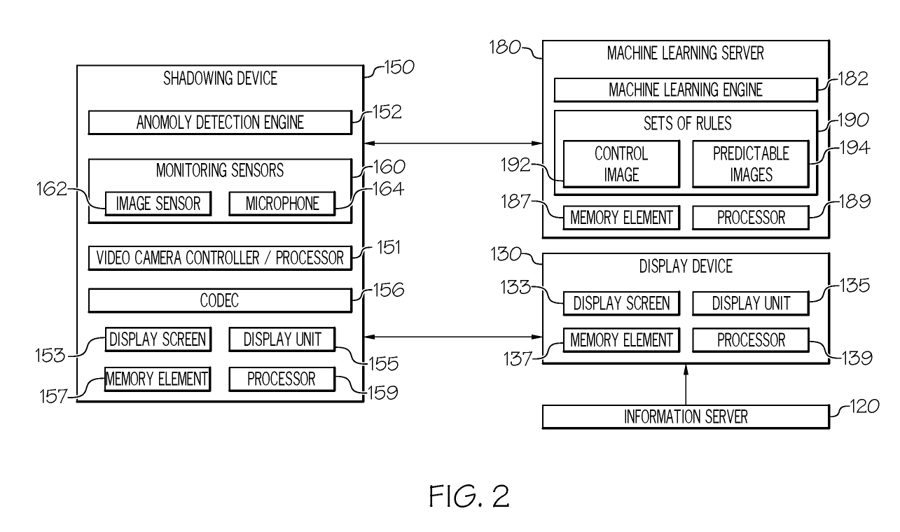

Embodiments described herein for unsupervised anomaly detection using shadowing of an HCI channel, as outlined in FIGS. 1 and 2, can address the above-discussed issues, as well as others not explicitly described. In an embodiment, images representing information related to monitoring a particular thing can be rendered on a display screen of a display device (e.g., 130). The images can be in the form of a video in which images (or frames) are displayed in the display screen in succession such that at least some of the objects in the images appear to be moving or changing at least some of the time. In other scenarios, the frame rate may be lower, such that fewer total images are displayed and thus, may appear to be static images that are periodically updated. A shadowing device (e.g., 150) can record the images rendered on the display screen and capture the video input stream of the recording for evaluation and possible anomaly detection. Frames of the video input stream can be evaluated against a set of rules that defines a control image to determine whether an anomaly is present in a frame or otherwise associated with the video input stream. The set of rules defining the control image may be generated by a machine learning server (e.g., 180) that applies deep learning techniques to prior frames of the video input stream (and/or frames of prior video input streams), to extract patterns from the prior frames to identify a usual (or expected) image for the display screen. This usual image is the control image for the particular images being evaluated. The set of rules that defines this control image can be inferred, at least in part, from the extracted patterns. If a determination is made that an anomaly is present in a frame or otherwise associated with the video input stream based on the set of rules, an appropriate alert can be generated and/or alert information can be logged. In one example, an alert can be sent to a user device (e.g., 110). In other examples, shadowing device 150 can also function as a user device to which an alert is sent.

In another embodiment, images representing information related to monitoring a particular thing can be rendered on a display screen of a shadowing device itself (e.g., 140). The images can be in the form of a video in which images (or frames) are displayed in the display screen in succession such that at least some of the objects in the images may appear to be moving or changing at least some of the time. In other scenarios, the frame rate may be lower, such that fewer total images are displayed and thus, may appear to be static images that are periodically updated. The shadowing device (e.g., 140) can capture images (or frames) to be rendered on the display screen. Frames of the data output signals can be evaluated against a set of rules that defines a control image to determine whether an anomaly is present in a frame or otherwise associated with the data output signals. The set of rules defining the control image may be generated by a machine learning server (e.g., 180) that applied deep learning techniques to prior frames in the data output signals (and/or frames of prior data output signals), to extract patterns from the prior frames to identify a usual (or expected) image to be displayed on the display screen. This usual image is the control image based on the particular images being evaluated. The set of rules that defines this control image can be inferred, at least in part, from the extracted patterns. If a determination is made that an anomaly is present in a frame or otherwise associated with the data output signals based on the set of rules, an appropriate alert can be generated and/or alert information can be logged. In one example, an alert can be sent to a user device (e.g., 110). In yet other examples, the shadowing device 140 can also function as a user device to which an alert is sent.

As used herein, an ‘anomaly’ is intended to mean one or more unexpected changes or unexpected patterns that occur in one or more images of a series of images rendered on a display screen, where the series of images are a human-cognizable presentation of something being monitored, and where the change indicates an aberration in the state or condition of the thing being monitored. These unexpected changes can include visual and/or audio changes. In some scenarios, an unexpected change could be any change to any one or more portions of a frame or to a particular one or more portions of a frame. In another example, an unexpected change could be a particular change to any one or more portions of a frame or to a particular one or more portions of a frame. In other scenarios, certain changes may be expected and considered trivial changes that do not indicate an anomaly. An anomaly may be detected in numerous ways when unexpected changes are identified. For example, an anomaly may be detected based on identifying an unexpected change to a threshold number of portions of a frame or to one or more particular portions of the frame. In another example, an anomaly may be detected based on identifying an unexpected change to the same (or corresponding) portions of a threshold number of frames in succession, a threshold number of frames over a period of time (e.g., 75 frames over 10 seconds), or a threshold number of frames in a specified number of frames (e.g., 75 frames out of 100 frames). Anomalies may also be detected if an unexpected pattern is identified based on applying the rules to a certain number of successive frames. For example, each frame may satisfy the set rules but the pattern observed in one or more corresponding portions may be an unexpected pattern.

Several examples of anomalies are now provided for illustrative purposes. In a first example, a series of images displayed on a display screen may show a line plot of a process that plots the amplitude of something on the y-axis versus time on the x-axis (e.g., population growth of a particular bacteria over time). If images on the display screen typically show an exponential decay, then an exponential decay with some slight variations is considered a usual image. However, if a secondary peak appears in the images, this change is a rare occurrence, or unexpected, and can be identified as an anomaly. In a second example, the air monitor in a home is typically set to 75 degrees and, therefore, the indoor temperature is usually 75. If an image in the display screen suddenly indicates the indoor temperature is 90 degrees, then this change is unexpected and can be identified as an anomaly. In some scenarios, certain predictable changes are not identified as legitimate anomalies. For example, if the temperature during working hours is usually 80 degrees, then an image showing 80 degrees indoors on a Wednesday at noon is expected and not identified as a legitimate anomaly. In another example, airports typically have display screens that show flight numbers, gates, arrival and departure times, and statuses. If the gate number changes or if the status changes from ‘on-time’ to ‘delayed,’ these may be unexpected changes and could be identified as anomalies. In a further example, a monitoring system may display a series of images that show a flashing light steadily over time. The individual flashes can be considered usual or expected changes in a series of images. However, if the alert stops flashing or if the flashes change colors, for example, then an unexpected pattern may be identified and an anomaly can be detected.

Embodiments disclosed herein provide several advantages. For example, some embodiments allow unsupervised monitoring and anomaly detection by a shadowing device from the images rendered on a display screen of an HCI channel, or the images to be rendered on a display screen of an HCI channel. Thus, human monitoring and evaluation of such display screens can be eliminated or significantly reduced. Additionally, a shadowing device can identify unexpected changes and detect anomalies of images being displayed on a display screen without needing to know the source of the information in the images. Thus, numerous HCI channels can be automatically monitored for anomalies without accessing data streams from the particular information sources of the displayed images. In addition, some monitoring systems provide various types of monitoring for the same thing and display different images on multiple display screens. When an anomaly occurs, this may trigger multiple alerts and/or alarms, which can be overwhelming to a human operator trying to monitor one or more display screens. Embodiments herein produce a clean alarm channel by filtering out the duplicative anomalies that are detected.

Turning to FIG. 2, FIG. 2 is a simplified block diagram showing possible details of shadowing device 150, machine learning server 180, and display device 130. Information server 120 is also shown in FIG. 2. As previously discussed herein, machine learning server 180 may be provisioned on a separate machine or may be integrated with shadowing device 150. Information server 120 may be integrated with the display device 130 or may be provisioned in a separate machine. For ease of description, FIG. 2 illustrates each of the elements (e.g., 120, 130, 150, 180) as separate machines.

One or more information servers, such as information server 120, can be provisioned in computing environment 100. Examples of information server 120 can include, but are not necessarily limited to, a web server, application server, database system, or mainframe system. Information server 120 can be configured to provide information via an HCI channel to be consumed by one or more human operators. In an HCI channel, such as display device 130, the information can be rendered on a display screen in a human-cognizable configuration with human-understandable imagery. One example of a human-cognizable configuration is a dashboard, which is a user interface that organizes and presents information in a way that is easy for a human operator to consume (e.g., monitor, read, evaluate, assess, compare, etc.). Human-understandable imagery can include, but is not necessarily limited to, graphs and plots (e.g., line, scatter, etc.), grids of lights, flashing lights, text, a table with fields of text (e.g., transportation display screens of flights/buses/boats/ferries/taxicabs with gates, terminals, platforms, arrival and departure times, and vehicle status such as ‘on-time’ or ‘delayed,’ etc.), scrolling windows of text, and a real-time view of a surveillance area (e.g., home, office, manufacturing plants, prisons, high-security government property, homeland borders, or any other places with a live security camera). In some scenarios, the information being rendered on a display screen can include sounds and/or messaging. Information server 120 can provide this information to be rendered on the display screens of HCI channels (e.g., display device 130), and may be locally or remotely provisioned relative to the HCI channels. In some implementations, information server 120 may be integrated with an HCI channel.

In at least one embodiment, display device 130 is an output device for presentation of information from information server 120 in a visual and possibly graphical form. Display device 130 includes a display screen 133, a display unit 135, a memory element 137, and a processor 139. Display device 130 can receive information from information server 120 to be displayed on display screen 133. Processor 139 can send instructions to the display unit 135 indicating what is to be displayed on display screen 133. Display unit 135 can convert the instructions into a set of corresponding signals that can be used to generate an image on display screen 133. Furthermore, in some embodiments, the display device may include a microcontroller and/or may be coupled to another computing device (e.g., information server 120 or some other device) by a cable over which the information to be displayed can be sent.

Display screen 133 can include, but is not necessarily limited to, a liquid crystal display (LCD) I/F, an organic light emitting device (OLED), or plasma display, any of which may be associated with mobile industry processor interface (MIPI)/high-definition multimedia interface (HDMI) links that couple to the display. In another example, display screen could be provided by a cathode ray tube (CRT) display. Essentially, any type of display screen that is capable of displaying human-cognizable imagery and being recorded by video may be used in particular implementations of one or more embodiments described herein.

Shadowing device 150 is a computing device and is configured to monitor display screen images rendered on a display screen (e.g., 133) of a separate device (e.g., 130) by performing a video recording of the displayed screen images. Shadowing device 150 includes an anomaly detection engine 152, monitoring sensors 160, a video camera controller/processor 151, a display screen 153, a display unit 155, a codec 156, a memory element 157, and a processor 159. Monitoring sensors 160 can include an image sensor 162 and a microphone 164.

Shadowing device 150 can record images that are displayed on display screen 133 of display device 130, and may also function as an output device for displaying its video recordings. Processor 159 can send instructions to display unit 155 indicating what is to be displayed on display screen 153. Display unit 155 can convert the instructions into a set of corresponding signals that can be used to generate an image on display screen 153. Display screen 153 can include, but is not necessarily limited to, a liquid crystal display (LCD) I/F, an organic light emitting device (OLED), or plasma display, any of which may be associated with mobile industry processor interface (MIPI)/high-definition multimedia interface (HDMI) links that couple to the display. Any suitable type of display screen that could be integrated in shadowing device 150 for displaying video recordings may be used in particular implementations of one or more embodiments described herein.

Video camera controller/processor 151, image sensor 162, and microphone 164 cooperate to enable video recordings by shadowing device 150. In at least one embodiment, video camera controller/processor 151 (or media processor) can be a microprocessor configured to manage digital streaming data in real-time. In one example, the video camera controller/processor 151 can be a specialized digital signal processor (DSP) used for image processing. In at least one example, image sensor 162 is an image-sensing microchip such as a charge-coupled device (CCD). Image sensor 162 captures light through a small lens and converts the picture represented by the light into a video input stream, which includes a series of frames. Each frame comprises a series of digits. Microphone 164 is a type of transducer, which can detect sound waves and convert the sound waves into an audio signal. Codec 156 can encode an audio signal into a digital signal.

Anomaly detection engine 152 can be provided on shadowing device 150 to examine frames of video input streams to determine whether an anomaly is present in a frame or otherwise associated with the video input stream. In at least one embodiment, an anomaly may be detected based on examining one or more frames according to a set of rules that defines a control image. The set of rules can be provided by machine learning server 180. Each rule of the set of rules can be applied to at least a portion of a frame to determine whether the portion of the frame satisfies that rule. In some scenarios, if the set of rules is satisfied by a frame, then the frame is not associated with any anomalies. In other scenarios, if a threshold number of frames in a set of multiple frames each satisfy the set of rules, then an anomaly is not associated with the multiple frames. In yet other scenarios, if an expected pattern is identified across a set of successive frames based on applying the set of rules to the successive frames, then an anomaly is not associated with the successive frames. In some scenarios, an anomaly can be detected based on identifying one or more unexpected changes in one or more frames. In other scenarios, an anomaly can be detected based on identifying an unexpected pattern over a certain number of successive frames. Anomaly detection engine 152 can also take an appropriate action if an anomaly is detected. In at least one embodiment, if an anomaly is detected, anomaly detection engine 152 can send an alert and/or log information related to the detected anomaly.

One or more machine learning servers, such as machine learning server 180, can be provisioned in computing environment 100. Examples of machine learning server 180 can include, but are not necessarily limited to, a web server, application server, database system, or mainframe system. In at least one embodiment, machine learning server 180 provides deep learning functionality to identify stable patterns in observed images. Machine learning server 180 can include machine learning engine 182, sets of rules 190, a memory element 187, and a processor 189. The sets of rules 190 can include a set of rules that defines a control image 192 and sets of rules that define predictable images 194. In some scenarios, the set of rules that defines the control image 192 can accommodate expected or trivial changes to the control image. For example, a rule for a portion of a graph with a plot line may include a range of values that a corresponding portion in a frame being evaluated can satisfy. In another example, a rule for a portion of a frame in which a steady flashing light is displayed may include both the flash and the intervening non-flash displays as satisfying the rule.

Machine learning server 180 can receive shadow signals from shadowing device 150. In one embodiment, a shadow signal is a video input stream recorded from images rendered on display screen 133 of display device 130. The shadow signal comprises a series of frames. Each frame of the shadow signal corresponds to an observed image to be evaluated by machine learning engine 182. In one example, machine learning engine 182 can use neural networks to learn from at least some of the frames in the shadow signal. For example, the frames in a shadow signal over a period of time may be evaluated by neural networks to extract patterns and create rules that define a control image for the particular human-understandable imagery rendered on display screen 133 and recorded by shadowing device 150. A control image derived from a video input stream is the usual image that was displayed in the display screen (e.g., 133) during the recording that produced the video input stream. The neural networks in machine learning engine 182 can automatically infer a set of rules that defines the control image (e.g., 192) for the particular frames processed by the machine learning engine 182 to learn the rules. The set of rules can accommodate any trivial or expected changes or variations of the image.

In some examples, the set of rules for a control image may be created during a training period in which at least a portion of a shadow signal is processed by machine learning engine 182. In some scenarios, an entire shadow signal or multiple shadow signals may be processed by machine learning engine 182 during the training period to create the set of rules that defines the control image. Once the training period is over, the set of rules can be applied to observed images (i.e., frames) of the remaining shadow signal (if any) and/or to observed images of subsequent shadow signals. Additionally, subsequent observed images may continue to be used by machine learning engine 182 to update the set of rules for control image 192.

Machine learning server 180 may also generate one or more sets of rules for predictable images 194. In at least some scenarios, changes may occur in a video input stream that do not correspond to the control image, but also do not represent a legitimate anomaly. Such changes may be predictable images that can be disregarded during anomaly detection of the relevant HCI channel. In these scenarios, a set of frames may be evaluated to learn the predictable image (e.g., by extracting patterns) and to generate a set of rules that defines the predictable image. It should be noted that one or more predictable images may be associated with any human-understandable imagery being displayed. It should also be noted that the set of rules for the control image 192 and one or more other sets of rules for predictable images 194 may be combined in any suitable manner to enable anomaly detection and filtering out the predictable images. In one illustrative example of a predictable image, a home surveillance monitor could render, on a display screen, a live feed of a particular area of a home when its occupants are gone. A control image for the live feed can be associated with an undisturbed view of the particular area of the home. A predictable image may be associated with a pet traversing the area being recorded.

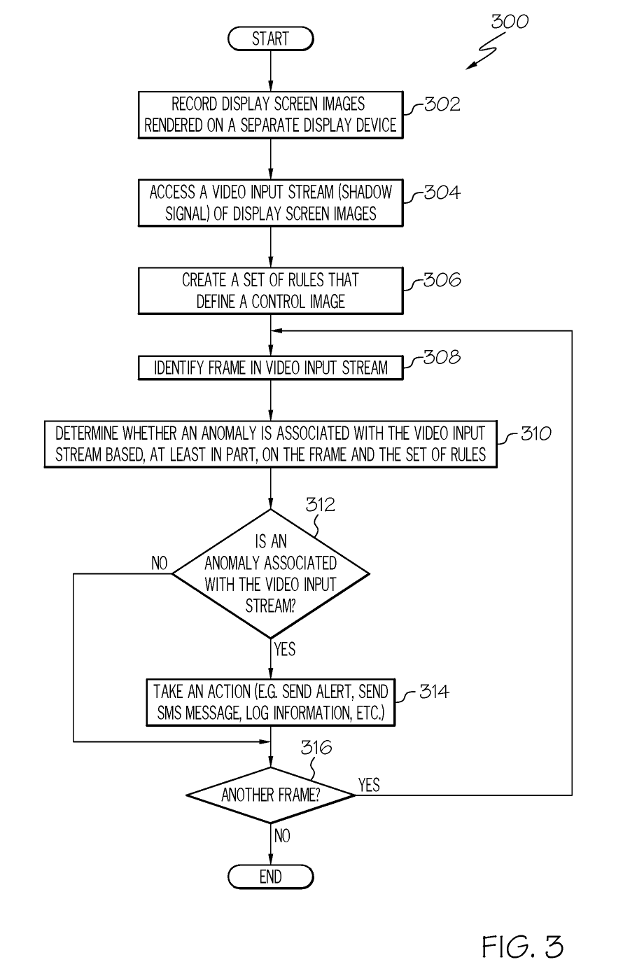

Turning to FIG. 3, a simplified flowchart 300 is presented illustrating example techniques associated with unsupervised anomaly detection using shadowing of HCI channels. In at least one embodiment, one or more sets of operations correspond to activities of FIG. 3. Shadowing device 150, monitoring sensors 162 and 164, and machine learning server 180, or portions thereof, may utilize the one or more sets of operations. Shadowing device 150 may comprise means such as processor 159 for performing the operations. Machine learning server 180 may comprise means such as processor 189 for performing the operations. In an embodiment, anomaly detection engine 152 and machine learning engine 182 may each perform at least some operations of flowchart 300.

At 302, shadowing device 150 records display screen images rendered on display screen 133 of display device 130. The recording produces a shadow signal, or video input stream comprising multiple frames. At 304, the video input stream is accessed. The video input stream can be provided to machine learning server 180, for creating or updating a set of rules that defines a control image that represents the usual imagery rendered on display screen 133.

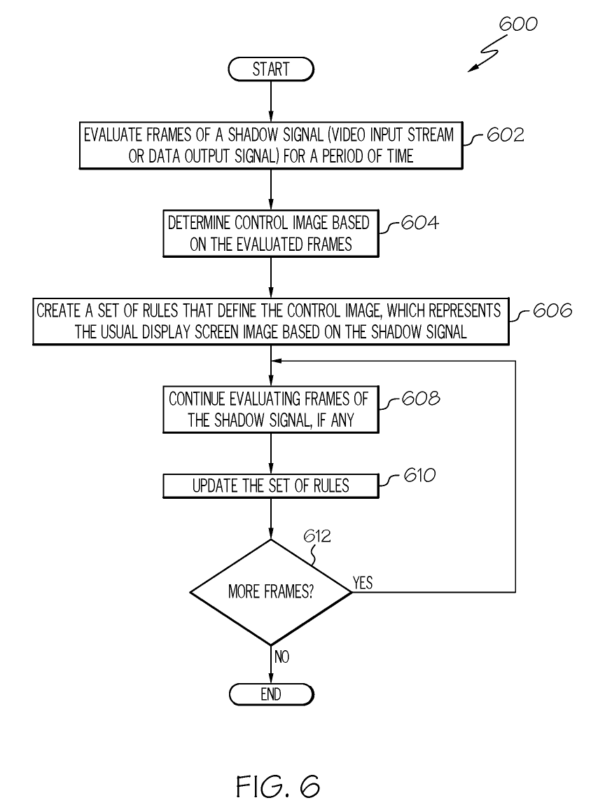

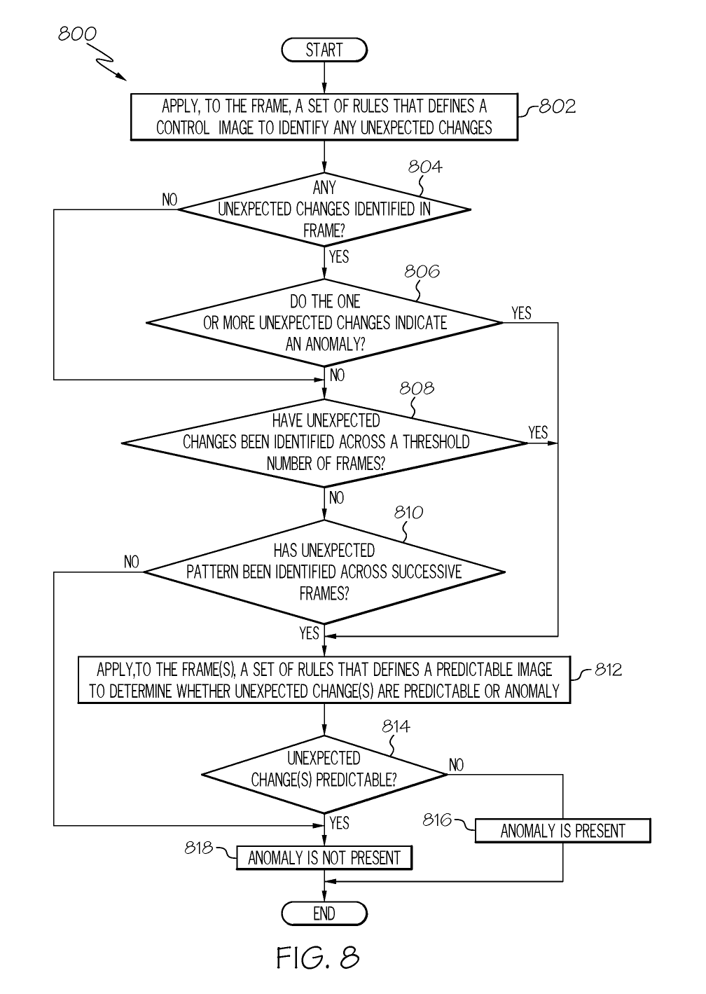

At 306, a set of rules that defines a control image for the video input stream may be created. One example of creating a set of rules is described in more detail with reference to FIG. 6. In other examples, a set of rules may have already been created based on prior video input streams, for example. At 308, a first frame in the video input stream is identified. At 310, a determination is made as to whether an anomaly is present in the first frame or otherwise associated with the video input stream. The determination is based, at least in part, on applying the set of rules that defines the control image to the first frame. In some scenarios, one or more other sets of rules that define predictable images may also be applied to the first frame to determine whether an unexpected change in the first frame is predictable and should be filtered out. An example of the processing, indicated at 310, is described in further detail with reference to FIG. 8.

At 312, if an anomaly is determined to be present in the first frame of the video input stream, or otherwise associated with the video input stream, then at 314, an action can be taken. Examples of possible actions include, but are not necessarily limited to, sending an alert (e.g., in the form of a notification, pop-up, alarm, etc.) to a user device, sending a short message service (SMS) message to a user device, sending an alert to another device (e.g., control or system monitor), logging information related to the anomaly in a file or other storage element, or any suitable combination thereof. If multiple anomalies are detected, one or more of the anomalies can be filtered out to allow a clean alarm channel (e.g., an action can be taken to represent one of the detected anomalies or a combination of the detected anomalies). For example, if the shadowing device detects anomalies that include an audio alarm, a flashing alert, and a change in the usual information (e.g., spike in decay plot) for example, the shadowing device may send a single alert to a user device and/or record a single entry in a log indicating that there was a spike in the decay plot.

At 316, a determination is made as to whether the video input stream contains another frame. If another frame is contained in the video input stream, then flow passes to 308, where the next frame in the video input stream is identified and anomaly detection processing continues at 310-314. If it is determined at 316 that no more frames are contained in the video input stream, however, then the flow can end.

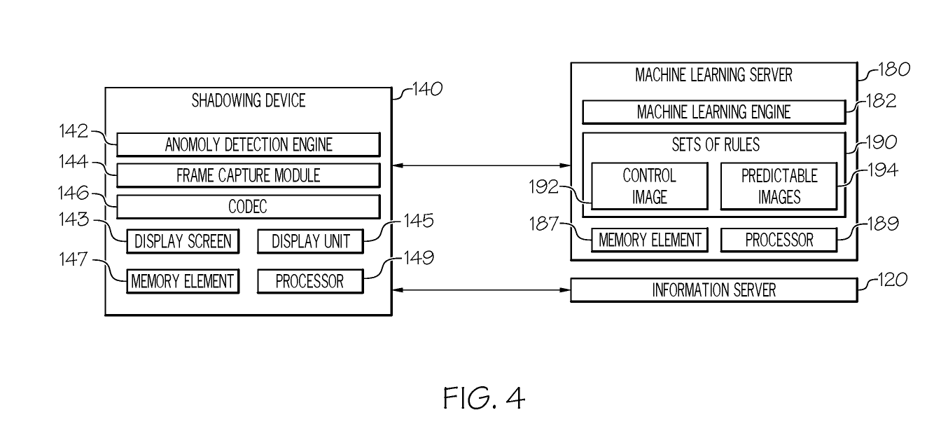

Turning to FIG. 4, FIG. 4 is a simplified block diagram showing possible details of shadowing device 140 and machine learning server 180. Information server 120 is also shown in FIG. 4. As previously discussed herein, machine learning server 180 may be provisioned on a separate machine or may be integrated with shadowing device 140. Information server 120 may be integrated with the shadowing device 140 or may be provisioned in a separate machine. For ease of description, FIG. 4 illustrates each of the elements (e.g., 120, 140, 180) as separate machines.

Information server 120 and machine learning server 180 have been previously described herein, for example, with reference to FIGS. 2-3. In this embodiment, however, information server 120 is configured to provide information via an HCI channel to be consumed by one or more human operators, where the HCI channel is display screen 143 of shadowing device 140. The information can be rendered on display screen 143 of shadowing device 140 in a human-cognizable configuration with human-understandable imagery, as previously described herein.

Shadowing device 140 is a computing device and is configured to monitor display screen images to be rendered on its own display screen 143. Shadowing device 140 can perform this monitoring by capturing frames of data output signals, for example using frame capture module 144, before the frames are rendered on the display screen 143. Shadowing device 140 includes an anomaly detection engine 142, frame capture module 144, a codec 146, display screen 143, a display unit 145, a memory element 157, and a processor 159.

Shadowing device 140 can function as an output device for presenting information from information server 120 as human-recognizable imagery. Shadowing device 140 can receive information from information server 120 to be displayed on display screen 143. Codec 146 is configured as an electronic circuit or software that decompresses digital video from information server 120 so that it can be displayed on display screen 143. Processor 149 can send instructions to display unit 145 indicating what is to be displayed on display screen 143. Display unit 145 can convert the instructions into a set of corresponding data output signals that can be used to generate an image on display screen 143. Display screen 143 can include, but is not necessarily limited to, a liquid crystal display (LCD) I/F, an organic light emitting device (OLED), or plasma display, any of which may be associated with mobile industry processor interface (MIPI)/high-definition multimedia interface (HDMI) links that couple to the display. Any suitable type of display screen that could be integrated in shadowing device 140 for displaying human-understandable imagery may be used in particular implementations of one or more embodiments described herein.

Anomaly detection engine 142 can be provided on shadowing device 140 to examine frames of data output signals to determine whether an anomaly is present in a frame or otherwise associated with the data output signals. In at least one embodiment, an anomaly may be detected based on examining one or more frames according to a set of rules that defines a control image, as previously described herein. The set of rules can be provided by machine learning server 180. Each rule of the set of rules can be applied to a portion of a frame to determine whether the portion of the frame satisfies that rule. If the set of rules is satisfied by a frame, then the frame is not associated with any anomalies. In other scenarios, if a threshold number of frames in a set of multiple frames each satisfy the set of rules, then an anomaly is not associated with the multiple frames. In yet other scenarios, if an expected pattern is identified across a set of successive frames based on applying the set of rules to the successive frames, then an anomaly is not associated with the successive frames. In some scenarios, an anomaly can be detected based on identifying one or more unexpected changes in one or more frames. In other scenarios, an anomaly can be detected based on identifying an unexpected pattern over a certain number of successive frames. Anomaly detection engine 142 can also take an appropriate action if an anomaly is detected. In at least one embodiment, if an anomaly is detected, anomaly detection engine 142 can send an alert and/or log information related to the detected anomaly.

Machine learning server 180 can receive shadow signals from shadowing device 140. In one embodiment, a shadow signal includes one or more data output signals that are produced by shadowing device 140 to be rendered on the shadowing device's display screen 143. Frame capture module 144 can capture the data output signals and provide the signals to machine learning server 180. The shadow signal comprises a series of frames. Each frame of the shadow signal corresponds to an observed image to be evaluated by machine learning engine 182. In one example, machine learning engine 182 can use neural networks to learn from at least some of the frames in the shadow signal, as previously described herein. For example, the frames in a shadow signal over a period of time may be evaluated by neural networks to extract patterns and create rules that define a control image for the particular human-understandable imagery being monitored. A control image derived from data output signals is the usual image that is to be displayed in a display screen (e.g., 143) of the shadowing device (e.g., 140) that produces and captures the data output signals. In machine learning server 180, the neural networks can automatically infer a set of rules that defines the control image for the particular frames processed by the machine learning engine 182 to learn the rules. The set of rules can accommodate any trivial or expected changes or variations of the image.

In some examples, the set of rules for a control image may be created during a training period in which at least a portion of a shadow signal is processed by machine learning engine 182. In some scenarios, an entire shadow signal or multiple shadow signals may be processed by machine learning engine 182 during the training period to create the set of rules that defines the control image. Once the training period is over, the set of rules can be applied to frames of the remaining shadow signal (if any) and to frames of subsequent shadow signals. Additionally, subsequent frames may continue to be used by machine learning engine 182 to update the set of rules for the control image 192. Also, as previously discussed herein, machine learning server 180 may generate one or more sets of rules for predictable images 194. The sets of rules for predictable images 194 can accommodate changes that may occur in data output signals that do not correspond to the control image, but also do not represent a legitimate anomaly (e.g., pet walking in front of home security camera).

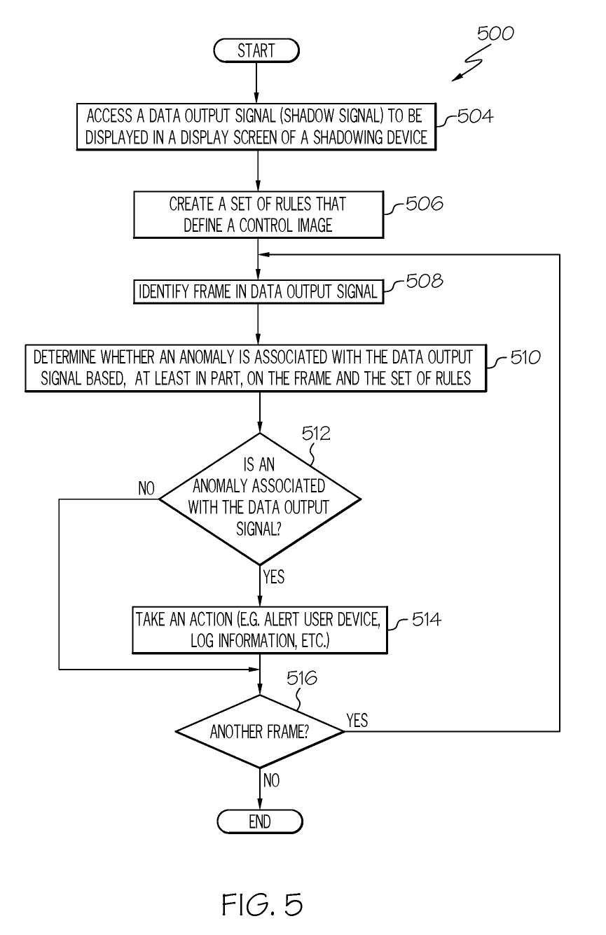

Turning to FIG. 5, a simplified flowchart 500 is presented illustrating example techniques associated with unsupervised anomaly detection using shadowing of HCI channels. In at least one embodiment, one or more sets of operations correspond to activities of FIG. 5. Shadowing device 140 and machine learning server 180, or portions thereof, may utilize the one or more sets of operations. Shadowing device 140 may comprise means such as processor 149 for performing the operations. Machine learning server 180 may comprise means such as processor 189 for performing the operations. In an embodiment, anomaly detection engine 142 and machine learning engine 182 may each perform at least some operations of flowchart 500.

At 504, a data output signal to be displayed in a display screen of a shadowing device (e.g., 140) is accessed or captured by the shadowing device. The data output signal can include a series of one or more images, where each image is represented by a frame of digits. The data output signal can be provided to machine learning server 180, to be used with other data output signals for creating or updating a set of rules that defines a control image that represents the usual imagery to be rendered on display screen 143.

At 506, a set of rules that defines a control image for the data output signals may be created. One example of creating a set of rules is described in more detail with reference to FIG. 6. In other examples, a set of rules may have already been created based on prior data output signals, for example. At 508, a first frame in the data output signal is identified. At 510, a determination is made as to whether an anomaly is present in the first frame or otherwise associated with the data output signal. The determination is based, at least in part, on applying the set of rules that defines the control image to the first frame. In some scenarios, one or more other sets of rules that define predictable images may also be applied to the first frame to determine whether an unexpected change in the first frame is predictable and should be filtered out. An example of the processing, indicated at 510, is described in further detail with reference to FIG. 8.

At 512, if an anomaly is determined to be present in the first frame of the data output signal, or otherwise associated with the data output signal, then at 514, an action can be taken. Examples of possible actions include, but are not necessarily limited to, sending an alert (e.g., in the form of a notification, pop-up, alarm, etc.) to a user device, sending a short message service (SMS) message to a user device, sending an alert to another device (e.g., control or system monitor), logging information related to the anomaly in a file or other storage element, or any suitable combination thereof. As previously described herein, if multiple anomalies are detected, one or more of the anomalies can be filtered out to allow a clean alarm channel (e.g., an action can be taken to represent one of the detected anomalies or a combination of the detected anomalies), as previously described herein.

At 516, a determination is made as to whether the data output signal contains another frame. If another frame is contained in the data output signal, then flow passes to 508, where the next frame in the data output signal is identified and anomaly detection processing continues at 510-514. If it is determined, at 516, that no more frames are contained in the data output signal, however, then the flow can end.

In FIG. 6, a simplified flowchart 600 is presented illustrating example techniques associated with unsupervised anomaly detection using shadowing of HCI channels. In at least one embodiment, one or more sets of operations correspond to activities of FIG. 6. Machine learning server 180, or portions thereof, may utilize the one or more sets of operations. Machine learning server 180 may comprise means such as processor 189 for performing the operations. In an embodiment, machine learning engine 182 may perform at least some operations of flowchart 600.

At 602, frames of a shadow signal are evaluated by machine learning engine 182. In some embodiments described at least with reference to FIGS. 2-3, the shadow signal evaluated by the machine learning engine can be a video input stream where a shadowing device, such as shadowing device 150, records images rendered on a display screen of a separate device. In other embodiments described at least with reference to FIG. 4-5, the shadow signal evaluated by the machine learning engine can be a data output signal where a shadowing device, such as shadowing device 140, captures the frames of the data output signal that are to be displayed on the display screen of the shadowing device.

In at least one implementation, machine learning engine 182 uses neural networks to learn from at least some of the frames in the shadow signal. For example, frames may be evaluated for a period of time designated for training. Neural networks can be used to learn from the frames during the period of time. At 604, a control image is derived from patterns extracted from the frames of the shadow signal being evaluated during the training period. In one embodiment, the control image can be derived from a video input stream and represents a usual display screen image with expected and trivial variations and changes (but without anomalies) rendered on a display screen. In another embodiment, the control image can be derived from one or more data output signals and represents a usual display screen image with expected and trivial variations and/or changes (but without anomalies) to be rendered on a display screen. At 606, a set of rules can be created that define the control image.

After the training period has ended, at 608, subsequent frames of the shadow signal (if any) may continue to be evaluated in order to learn additional information and possibly update the set of rules at 610. Moreover, frames of subsequent shadow signals may also be evaluated for learning and updating the set of rules. At 612, if it is determined that more frames are contained in the shadow signal, then flow passes to 608 to continue evaluating the remaining frames for additional information to potentially update the set of rules at 610. If it is determined, at 612, that no more frames are contained in the shadow signal (e.g., recording of display screen image has ceased, display on display screen of shadowing device has ended), then the flow ends. Additionally, after the training period is over, subsequent frames of the shadow signal (if any) may be evaluated based on the set of rules to determine whether an anomaly is present (e.g., 310, 510). In addition, frames of subsequent shadow signals may also be evaluated based on the same set of rules.

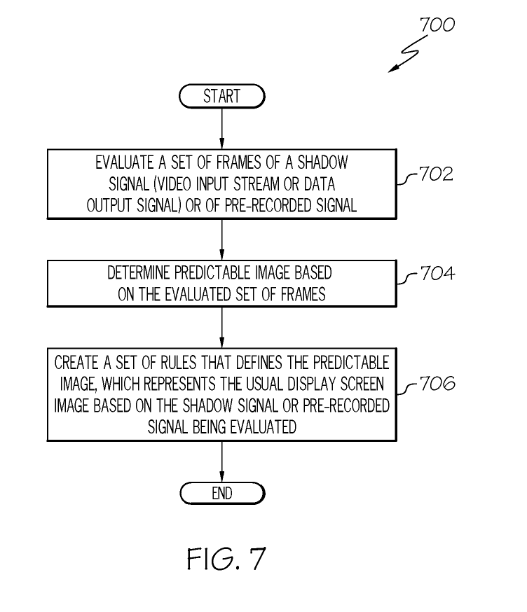

In FIG. 7, a simplified flowchart 700 is presented illustrating example techniques associated with unsupervised anomaly detection using shadowing of HCI channels. In at least one embodiment, one or more sets of operations correspond to activities of FIG. 7. Machine learning server 180, or portions thereof, may utilize the one or more sets of operations. Machine learning server 180 may comprise means such as processor 189 for performing the operations. In an embodiment, machine learning engine 182 may perform at least some operations of flowchart 700.

At 702, a set of frames of a shadow signal (e.g., a video input stream or data output signal) or of a pre-recorded signal are evaluated by machine learning engine 182. In at least one implementation, machine learning engine 182 uses neural networks to learn from at least some of the frames in the signal. For example, a particular set of frames may be evaluated to learn a predictable image that does not satisfy the set of rules for a control image, but is not a legitimate anomaly. A shadow signal could be used to create a set of rules that defines the predictable image if the shadow signal includes a set of frames containing the predictable image. Alternatively, a pre-recorded set of frames that includes the predictable image could be used by machine learning engine to create the set of rules. Neural networks can be used to learn from the set of frames during the training period.

At 704, a predictable image is determined from patterns extracted from the set of frames. The predictable image represents a usual display screen image based on the evaluated set of frames. At 706, a set of rules can be created that define the predictable image, which represents the usual display screen image based on the shadow signal or pre-recorded signal being evaluated (e.g., shadow signal, pre-recorded signal). In at least some scenarios, other frames may be evaluated at other times to learn additional information and update the set of rules that defines the predictable image.

In FIG. 8, a simplified flowchart 800 is presented illustrating example techniques associated with unsupervised anomaly detection using shadowing of HCI channels. In at least one embodiment, one or more sets of operations correspond to activities of FIG. 8. A shadowing device (e.g., 150, 140) and machine learning server 180, or portions thereof, may utilize the one or more sets of operations. The shadowing device may comprise means such as a processor (e.g., 159, 149) for performing the operations. Machine learning server 180 may comprise means such as processor 189 for performing the operations. In an embodiment, an anomaly detection engine (e.g., 152, 142) and machine learning engine 182 may each perform at least some operations of flowchart 800. In at least one embodiment, flowchart 800 provides additional possible details associated with operations that may be performed at 310 or 510, after a set of rules defining a control image has been created and a frame has been identified in the appropriate shadow signal (i.e., video input stream or data output signal).

At 802, a set of rules that defines a control image are applied to the identified frame to determine whether an image corresponding to the frame has one or more unexpected changes relative to the control image. Each rule of the set of rules can be applied to a portion of a frame, or to the whole frame depending on the rule, to identify any unexpected changes in the frame based on whether the portion of the frame, or the whole frame, satisfies that rule.

At 804, a determination is made as to whether any unexpected changes are identified in the frame. If one or more unexpected changes are identified in the frame, then at 806, a determination is made as to whether the identified unexpected changes indicate an anomaly. For example, an anomaly may be detected based on identifying any unexpected change to a threshold number of portions of a frame, any unexpected change to one or more particular portions of the frame, a particular change(s) to a threshold number of portions of a frame, or a particular change(s) to particular portion(s) of a frame. If an anomaly is detected, the flow can proceed to 812 to determine whether the unexpected change or changes represent a predictable anomaly or a legitimate anomaly, as will be further described herein.

If no unexpected changes are identified in the frame at 804, or if unexpected changes identified in the frame do not indicate an anomaly at 806, then checks may be performed to detect an anomaly across multiple frames of the shadow signal. At 808, a determination can be made as to whether unexpected changes have been identified across a threshold number of frames. In at least some scenarios, the unexpected changes may be identified in the same (or corresponding) portions of the multiple frames (e.g., particular fields of a dashboard). The unexpected changes can be evaluated across a threshold number of frames in succession, across a threshold number of frames over a period of time (e.g., 75 frames during a 10 second interval), across a threshold number of frames in a specified number of frames (e.g., 75 frames out of 100 frames), or any other suitable threshold related to the frames. If an anomaly is detected, the flow can proceed to 812 to determine whether the unexpected change(s) represent a predictable anomaly or a legitimate anomaly, as will be further described herein.

If an anomaly is not detected at 808 (unexpected changes are not identified across a threshold number of frames), then at 810, a check can be performed to determine whether an unexpected pattern has been identified across successive frames. For example, each frame may satisfy the set rules but the pattern observed in one or more corresponding portions of the successive frames may be an unexpected pattern that indicates an anomaly. By way of illustration, an expected flashing light in a display screen image may cause a portion of every other frame to represent a light and intervening frames to represent no light (blank/dark). Each of these frames may satisfy the rule applied to that portion of the frame because both options (i.e., light and no light) are valid representations in the pattern. However, if the light stops flashing on the screen, the resulting pattern of that portion (i.e., no light represented in successive frames) is an anomaly. If an unexpected pattern is not identified across successive frames, then at 818, an anomaly is determined not to be present in the successive frames or otherwise associated with the video input stream or data output signal. If an anomaly is detected (e.g., an unexpected pattern is identified), however, the flow can proceed to 812 to determine whether the unexpected pattern(s) represent a predictable anomaly or a legitimate anomaly, as will be further described herein.

When an anomaly is detected (e.g., 806, 808, 810), then in at least one embodiment, a further evaluation may be performed to determine whether the anomaly is a predictable anomaly. At 812, this further evaluation can include applying, to the frame (or frames when multiple frames are evaluated to detect an anomaly), a different set of rules that defines a predictable image. A predictable image is an image that differs from the control image, but does not represent a legitimate anomaly. For example, if the display screen being monitored (e.g., 133) displays a surveillance video inside a house, the control image may correspond to an undisturbed area within the house that is captured on the surveillance video. If a pet walks into the view of the surveillance video camera, this event could trigger an anomaly detection at 806, 808, or 810. This event, however, likely does not need an alert to be generated because it is not a legitimate anomaly that would be of interest to the homeowner.

At 814, if it is determined that the unexpected change or changes are predictable (e.g., cat walking in front of surveillance video camera), then a determination is made that a legitimate anomaly is not present in the frame or frames or otherwise associated with the shadow signal, as shown at 818. If it is determined that the unexpected change or changes are not predictable (e.g., an unknown human walking in front of surveillance video camera), then a determination is made that a legitimate anomaly is present in the frame or frames or otherwise associated with the shadow signal, as shown at 816.

It should be noted that the checks performed in FIG. 8 (e.g., 804-814) may be provided in any combination of a flow evaluating a shadow signal (e.g., video input stream or data output signal). For example, if an anomaly can be detected based on a change or changes to a single frame of the particular shadow signal being monitored, then checks at 808 and 810 may not need to be performed on any frames in the shadow signal. In another example, if anomalies are detected based only on identifying an unexpected pattern (e.g., flashing light stops or changes its frequency, color, intensity, etc.) in the particular shadow signal being monitored, then checks at 804-808 may not need to be performed on any frames in the shadow signal. In a further example, if anomalies are detected based on identifying unexpected changes across a threshold number of frames in a particular shadow signal, then checks at 804, 806, and 810 may not need to be performed on any frames in the shadow signal. Moreover, it should be apparent that any or all of the checks 804-810 may be performed on a particular shadow signal, and that other types of checks not necessarily explicitly described herein may also be performed alone or in combination with the checks shown and described with reference to FIG. 8 and/or in other parts of this disclosure.

The flowcharts and block diagrams in the Figures illustrate the architecture, functionality, and operation of possible implementations of systems, methods, apparatuses, and computer program products according to various aspects of the present disclosure. In this regard, each block or interaction in the flowchart, interaction, or block diagrams may represent a module, segment, logic, or portion of code, which comprises one or more executable instructions for implementing the specified logical function(s). It should also be noted that, in some alternative implementations, the functions noted in the block or interaction may occur out of the order noted in the figures. For example, two blocks or interactions shown in succession may, in fact, be executed substantially concurrently, or the blocks or interactions may sometimes be executed in the reverse order, depending upon the functionality involved. It should also be noted that each block or interaction of the block diagrams and/or flowchart illustrations, or combinations of blocks or interactions in the block diagrams and/or flowchart illustration, can be implemented by special purpose hardware-based systems that perform the specified functions or acts, or combinations of special purpose hardware and computer instructions.

As used herein, unless expressly stated to the contrary, use of the phrase ‘at least one of’ refers to any combination of the named elements, conditions, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z. Also, references in the specification to “one embodiment,” “an embodiment,” “some embodiments,” etc., indicate that the embodiment(s) described may include a particular feature, structure, or characteristic, but every embodiment may or may not necessarily include that particular feature, structure, or characteristic. Moreover, such phrases are not necessarily referring to the same embodiment. Additionally, unless expressly stated to the contrary, the terms ‘first’, ‘second’, ‘third’, etc., are intended to distinguish the particular nouns (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements, that are not necessarily limited by any order, rank, importance, temporal sequence, or hierarchy of the two elements.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
accessing, at a shadowing device, a video input stream of display screen images rendered on a display screen of a display device, the display screen images recorded by the shadowing device to produce the video input stream;
identifying, at the shadowing device, a first frame of the video input stream;
determining, at the shadowing device, whether an anomaly is associated with the video input stream based, at least in part, on applying a rule of a set of rules to at least a portion of the first frame, wherein the set of rules defines a control image associated with the video input stream; and
determining whether to take an action based on the determining whether the anomaly is associated with the video input stream.

2. The method of claim 1, wherein the anomaly is determined to be associated with the video input stream based, at least in part, on determining that the portion of the first frame does not satisfy the rule.

3. The method of claim 1, wherein the anomaly is determined to be not associated with the video input stream based on determining that each rule of the set of rules is satisfied by a respective portion of the first frame.

4. The method of claim 1, wherein the anomaly is determined to be not associated with the video input stream based, at least in part, on:
determining that the portion of the first frame does not satisfy the rule;
identifying a second set of rules that defines a predictable image; and
determining that the second set of rules is satisfied by the first frame.

5. The method of claim 1, wherein the anomaly is determined to be associated with the video input stream if at least a threshold number of rules of the set of rules are not satisfied by the first frame.

6. The method of claim 1, wherein the determining whether the anomaly is associated with the video input stream includes applying the rule of the set of rules to corresponding portions of a threshold number of frames that include the first frame and one or more frames accessed prior to the first frame.

7. The method of claim 6, wherein the anomaly is determined to be associated with the video input stream based on determining that the corresponding portions of the threshold number of frames do not satisfy the rule.

8. The method of claim 1, wherein the anomaly is determined to be associated with the video input stream based on identifying an unexpected pattern in a threshold number of successive frames that include the first frame and one or more frames accessed prior to the first frame.

9. The method of claim 1, wherein the portion of the first frame is a particular field associated with a display screen image corresponding to the first frame.

10. The method of claim 1, wherein the rule is based on a threshold value associated with the portion of the first frame.

11. The method of claim 1, wherein the action includes one or more of sending an alert to a user device and logging information associated with the anomaly.

12. The method of claim 1, wherein the set of rules that defines the control image is based on one or more frames received prior to the first frame in the video input stream.

13. The method of claim 1, wherein the control image is associated with a sound.

14. The method of claim 13, wherein the determining whether the anomaly is associated with the video input stream includes determining whether another rule is satisfied based on a sound associated with the first frame relative to the sound associated with the control image.

15. The method of claim 1, wherein the determining whether the anomaly is associated with the video input stream includes determining whether the rule is satisfied based on a color associated with the portion of the first frame.

16. A system comprising:
a memory element; and
a shadowing device including a processor to execute instructions stored in the memory element to:
recording display screen images rendered on a display screen of a display device;
access a video input stream based on the recording;
identify a first frame of the video input stream;
determine whether an anomaly is associated with the video input stream based, at least in part, on applying a rule of a set of rules to at least a portion of the first frame, wherein the set of rules defines a control image associated with the video input stream; and
determine whether to take an action based on determining whether the anomaly is associated with the video input stream.

17. The system of claim 16, further comprising:
a machine learning engine configured to:
create the set of rules based on evaluating at least some frames of the video input stream for a period of time; and
store the set of rules in the memory element.

18. The system of claim 17, wherein the machine learning engine is further configured to:
update the set of rules that defines the control image in real-time with one or more frames of the video input stream that are accessed subsequent to the period of time.

19. A computer program product comprising a computer readable storage medium comprising computer readable program code embodied therewith, the computer readable program code comprising:
computer readable program code configured to access a video input stream of display screen images rendered on a display screen of a display device, the display screen images recorded by a shadowing device;
computer readable program code configured to identify a first frame of the video input stream;
computer readable program code configured to determine whether an anomaly is associated with the video input stream based, at least in part, on applying a rule of a set of rules to at least a portion of the first frame, wherein the set of rules defines a control image associated with the video input stream; and
computer readable program code configured to determining whether to take an action based on the determining whether the anomaly is associated with the video input stream.

20. The computer program product of claim 19, wherein the anomaly is determined to be associated with the video input stream based, at least in part, on determining that the portion of the first frame does not satisfy the rule.
